(19) United States
(12) Patent Application Publication
(10) Pub. No.: US 2008/0147850 A1
(43) Pub. Date: Jun. 19, 2008

(54) Method for Operating a Data Communications Network Using License Data and Associated Device Network

(76) Inventor: Martin Schuschan, Schonenwalde (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/662,937

(22) PCT Filed: Jul. 25, 2005
(86) PCT No.: PCT/EP2005/053594

§ 371 Date: Sep. 10, 2007

(30) Foreign Application Priority Data
Sep. 17, 2004 (DE) 10 2004 045 192.3

(51) Int. Cl. G06F 15/16; G06F 21/00

(52) U.S. Cl. 709/224; 726/26

(57) ABSTRACT

In one aspect a method, wherein a service-provider computer monitors the maintenance of user conditions is provided. An additional user duration is fixed by taking into account disturbances during monitoring. In the event of a failure in monitoring, the use of a function by a service-user computer is authorized and or blocked according to the additional user duration.

### CROSS REFERENCE TO RELATED APPLICATIONS

This application is the US National Stage of International Application No. PCT/EP2005/053594, filed Jul. 25, 2005 and claims the benefit thereof. The International Application claims the benefits of German application No. 102004045192.3 DE filed Sep. 17, 2004, both of the applications are incorporated by reference herein in their entirety.

### FIELD OF INVENTION

The invention relates to a method and network wherein the following are performed:
generation of license data specifying usage conditions for the use of at least one function in a data communications network,
dependent on the license data, use of the function on at least one service using computer of the data communications network, and
monitoring of compliance with the usage conditions by a service providing computer.

### BACKGROUND OF INVENTION

The license is the granting of a right to use a function. The license data is typically generated by the licensor, taking into account the scope of the license or licenses granted. The function subject to licensing relates for example to the use of a program or the use of a switching unit. An example of a switching unit is the network element of the type hiX5300, which is manufactured by the company Siemens AG. An example of a program is the program SAP.

### SUMMARY OF INVENTION

In licensing, a distinction is made between licensing for a specific computer on the one hand and licensing for a specific number of simultaneous calls of the function irrespective of the computer used. Computer-related licensing is also referred to by the term “nodelocked license”. Computer-independent licensing, in contrast, is also referred to by the term “floating license”. The method according to the invention is suitable in particular for the computer-independent licensing of functions.

In the event of a problem disrupting the monitoring, the use of the function on the service using computer or service using computers could be inhibited. This would be a simple way of preventing misuse.

An object of the invention is to specify a simple method for operating a data communications network using license data, said method in particular preventing misuse and in particular nonetheless guaranteeing as disruption-free use of the function as possible by a user. An associated device network is also to be specified.

The object relating to the method and network is achieved via the independent claims. Developments are specified in the dependent claims.

The invention proceeds from the consideration that a floating license system which consists of a floating server or, as the case may be, a floating service providing computer and a plurality of license clients or, as the case may be, license service using computers has the disadvantage that it is very susceptible to disruption if the use of the function is also inhibited if there is a problem disrupting the monitoring. However, there is a requirement, in particular for communications networks which must provide a high level of reliability, for a floating license system which, in the event of a malfunction, supports a defined dynamic license return capability in order to preclude system failures. For this reason a dynamic license return controller which leads to a reliable and disruption-tolerant floating license system is used for the invention. The controller calculates a license return time or, as the case may be, an additional usage period. If malfunctions occur, the licenses are returned on a network element or, as the case may be, the service using computer after expiration of the license return time or, as the case may be, the additional usage period. In this way the licenses for the functions are not suspended immediately, but only at the end of the additional usage period. If no malfunctions occur, the license return time is increased in one embodiment.

In addition to the method steps cited in the introduction, the following method steps are also carried out in the method according to the invention, without any restriction applying in respect of the order in which the method steps are listed:
specification of an additional usage period, taking into account problems disrupting the monitoring, and
in the event of a problem disrupting the monitoring, use of the function dependent on the additional usage period.

In one development the license data specifies a number of simultaneous uses of at least one function or, as the case may be, accesses to said function in the data communications network. In this way a floating license system is supported.

In another development of the method according to the invention, the licensable function relates to the invocation and use of a program or a program part. Alternatively the function relates to the use of a switching unit or a subfunction of a switching unit, in particular in conjunction with the use of a program or a program part. The function is also referred to as a service feature. The licensing of service features with the aid of license data is in particular a preferred solution for the distribution and updating of programs via the internet.

In a next development of the method according to the invention, the following steps are performed:
specification of at least one check time window, an additional usage period belonging to the check time window and a check criterion belonging to the check time window which is a measure for allowed disruptions to the monitoring,
determination of the disruptions which have occurred in the check time window,
checking of the check criterion on the basis of the determined disruptions and
specification of the additional usage period dependent on the result of the check of the check criterion.

As a result of specifying a check time window, a very strong non-linearity in the assignment of additional usage periods is achieved. An aggregation of an ever-increasing bonus time over an increasing usage period is counteracted through the use of the check time window. This makes it more difficult to misuse the additional usage period. It also possible because of the check time window to specify the additional usage periods in an empirical manner such that the conditions prevailing in a data communications network are taken into account, in particular with regard to the susceptibility to disruption.

In a first development the time window is what is termed a “sliding” time window whose end time shifts with the current time, while the length of the time window is constant.

In a next development the following particularly suitable specifications are made:

length of the time window one day, additional usage period two hours,

length of the time window one week, additional usage period one day, and

length of the time window two weeks, associated usage period two days.

In another development the monitoring is repeatedly started automatically. When a constant monitoring interval is used, timers or counter circuits, for example, can easily be used. The monitoring interval lies within the range from five minutes to one hour, for example.

In another development of the method according to the invention, a disruption to the monitoring consists in no monitoring being possible during a monitoring interval. For example, no response message to a monitoring message is received by the service providing computer.

The following specifications are particularly suitable for monitoring according to intervals:
length of the time window one day, minimum monitoring availability in the range from 95 percent to 100 percent or from 97 percent to 98 percent, additional usage period two hours,
length of the time window one week, minimum monitoring availability in the range from 95 percent to 100 percent or from 97 percent to 98 percent, additional usage period one day, and
length of the time window two weeks, minimum monitoring availability in the range from 95 percent to 100 percent or from 97 percent to 98 percent, additional usage period two days.

In a next development at least two time windows, preferably, however, three time windows with associated additional usage periods and availability criteria, are specified. The availability criteria are checked for all time windows in each case. If several availability criteria are fulfilled, the user is provided with the longest additional usage period for which the associated availability criterion is fulfilled. A simple empirical specification of additional usage periods is also possible by means of this measure.

In a next development the service providing computer monitors the use of the function or of a different function on at least one further service using computer. The monitoring methods are performed in particular by the execution of the same method steps, with the result that a monitoring program on the service providing computer can be used multiple times for monitoring a plurality of service using computers. The same monitoring programs are used on the service using computers, thus minimizing the overhead for producing and maintaining the software.

In another development the usage conditions specify the use of a plurality of different functions. The additional usage period relates to the use of the different functions. In other words, when the additional usage period is specified, a distinction is not made according to the type of function to be used. With this approach the overhead for the monitoring method remains within reasonable bounds.

In another development the following steps are performed cyclically by the service using computer, without any restriction applying in respect of the order in which they are listed:
sending a monitoring message to the service providing computer,
if there is no response message to the monitoring message or if an incorrect response message is received, reducing the additional usage period by a predefined amount,
checking the remaining additional usage period, and
when the additional usage period has expired, suspending use of the function by the service using computer.

In this way compliance with the additional usage period can be monitored in a simple manner.

In another development the service providing computer cyclically performs the following steps, without any restriction applying in respect of the order in which they are listed:
reading an additional usage period date for a service using computer, the value of the additional usage period date specifying the additional usage period,
reading a monitoring date which specifies the time of the last message received from the service using computer during the monitoring,
checking whether the additional usage period has been exceeded as a function of the value of the monitoring date, and
if the additional usage period has been exceeded, updating license data for the release of licenses that have been allocated to the service using computer.

Performing these method steps results in an alignment of the additional usage period on the service using computer side and on the service providing computer side. After licenses have been released, they are available again for use by other service using computers.

The invention also relates to a device network for performing the method according to the invention or one of its developments. Accordingly, the above-mentioned technical effects also apply to the device network.

### BRIEF DESCRIPTION OF THE DRAWINGS

The invention is explained below with reference to the accompanying drawings, in which:

FIG. 1 shows a data communications network and method steps for using functions subject to licensing,

FIG. 2 shows a table for specifying additional usage periods,

FIG. 3 shows a timeline for illustrating the position of time windows that are used for specifying the additional usage period,

FIG. 4 shows method steps that are performed by a service using computer, and

FIG. 5 shows method steps that are performed by a service providing computer.

### DETAILED DESCRIPTION OF INVENTION

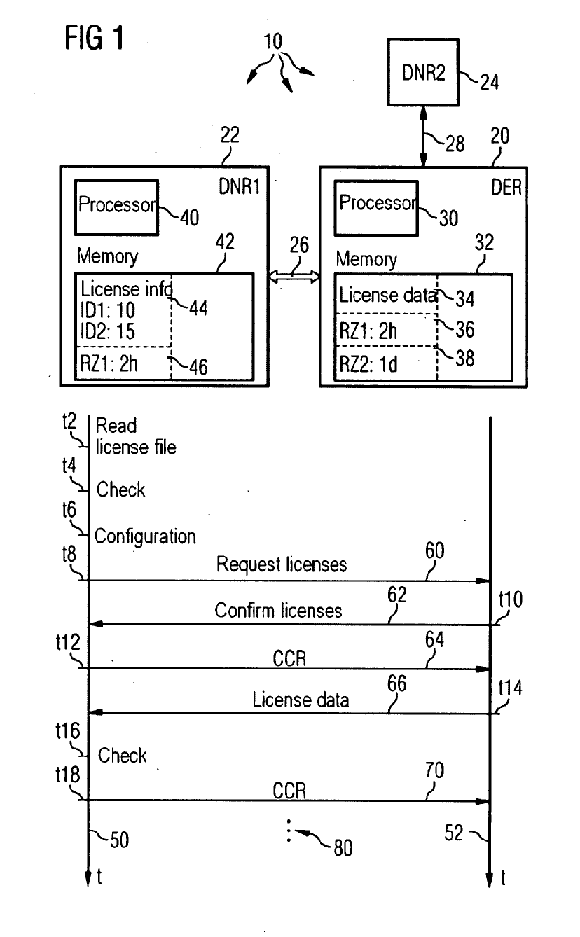

FIG. 1 shows a data communications network 10 in which a plurality of computers are interconnected or can be interconnected. The data communications network 10 is for example a data communications network that operates in accordance with the Internet Protocol. In the exemplary embodiment the data communications network 10 includes a service providing computer 20 and two service using computers 22, 24. The service providing computer 20 is for example a commercially available personal computer. The service using computer 22 is for example a network element of a telecommunications network for channel-based telecommunication or for data-packet-oriented telecommunication, e.g. for voice telephony or video telephony. The service using computer 22 is, for example, a network element of the type hiX5300 from the company Siemens AG. The service providing computer 20 operates as a server and communicates via data communication connections 26, 28 with the service using computers 22, 24, which are also referred to as clients.

The service providing computer 20 includes a processor 30, for example a microprocessor. The processor 30 executes commands which are stored with the aid of command data in a memory 32 of the service providing computer 20. In this arrangement the functions explained below are executed. License data 34 is also stored in the memory 32, for example. In order to counteract misuse, the license data 34 is stored only in a volatile memory 32, for example in a memory supporting random access (RAM—Random Access Memory). The license data 34 relates, for example, to:
the network addresses of the service providing computers 22, 24, and
service-related features for service features with identifiers ID1, ID2 etc. associated in each case with a number specifying the simultaneous use of these service features in the data communications network 10.

The license data 34 originates from a license file which is stored on an ftp (File Transfer Protocol) server (not shown) and contains, inter alia, the following data:
file identifiers,
customer name,
product name,
signature information,
creation date of the license file,
the network addresses of the service using computers 22, 24,
the network address of the service providing computer 20,
an optional expiration date,
and service-feature-related data for a service feature with the identifier ID1 and for a service feature different therefrom with the identifier ID2, in particular the number of simultaneously possible uses of the service features with the identifiers ID1 and ID2, and
a digital signature.

In the exemplary embodiment the service feature with the identifier ID1 can be used, for example, 50 times in the data communications network 10. The service feature with the identifier ID2 can be used 80 times in the data communications network 10.

The following data is also recorded in the memory unit 32:
for each service using computer 22, 24, an LCC (Last Cyclic Check) date in which the time of the last CCR message received is stored,
for each service using computer 22, 24, an additional usage period RZ1, RZ2 in a date 36 and 38 respectively, and
for each service using computer 22, 24, the number of currently used service features with the identifier ID1 or, as the case may be, ID2.

In the exemplary embodiment the additional usage period RZ1 for the service using computer 22 is two hours (2 h). The additional usage time RZ2 for the service using computer 24, on the other hand, is one day (1 d).

In the exemplary embodiment the service using computer 22 likewise includes a processor 40, for example a microprocessor. The service using computer 22 further includes a memory 42, for example a RAM memory. Stored in the memory 42 is command data during the processing of which by the processor 40 the method steps explained below with reference to the service using computer 22 are performed. Also stored in the memory 42 is license data 44, for example the number of simultaneous accesses to the service feature with the identifier ID1 that are permitted for the service using computer 22. In the exemplary embodiment this number is equal to ten. The number of simultaneous uses of the service feature with the identifier ID2 is stored in the memory 42 with a date which specifies the value fifteen.

Also stored in the memory 42 is an additional usage period date 46 in which the current additional usage period RZ1 of the service using computer 22 is recorded. In the exemplary embodiment the additional usage period RZ1 for the service using computer 22 is two hours.

In another exemplary embodiment the functions of the service providing computer 20, of the service using computer 22 or, as the case may be, of the service using computer 24 are provided by a switching unit which contains no processor.

The lower part of FIG. 1 shows two vertical timelines 50 and 52. The timeline 50 relates to events which concern the service using computer 22. The timeline 52, in contrast, relates to events which concern the service providing computer 20. Identical moments in time are marked off at the same levels of the timelines 50 and 52. Moments later in time are located lower down on the timelines 50, 52 than moments earlier in time.

At a time t2 the service using computer 22 reads the license data from the license file server, which is not shown in FIG. 1. At a following time t4 the service using computer 22 checks the digital signature contained in the license file, for example using a so-called private key and calculating a so-called hash value. In the exemplary embodiment it is assumed that the digital signature is valid.

At a time t6 the configuration necessary for using the service features with identifiers ID1 and ID2 is carried out, based on the valid signature. At a time t8 the service using computer 22 requests from the service providing computer ten licenses for using the service feature with the identifier ID1 and fifteen licenses for using the service feature with the identifier ID2; see license request message 60. Owing to the receipt of the license request message 60 in the service providing computer 20 the service providing computer 20 checks whether ten licenses are still available for the first service feature and fifteen licenses for the second service feature. The license file and license data 34 stored in the memory 32 are included here. In the exemplary embodiment the licenses are still available. The service providing computer 20 therefore acknowledges the license request message 60 at a time t10 with a confirmation message 62.

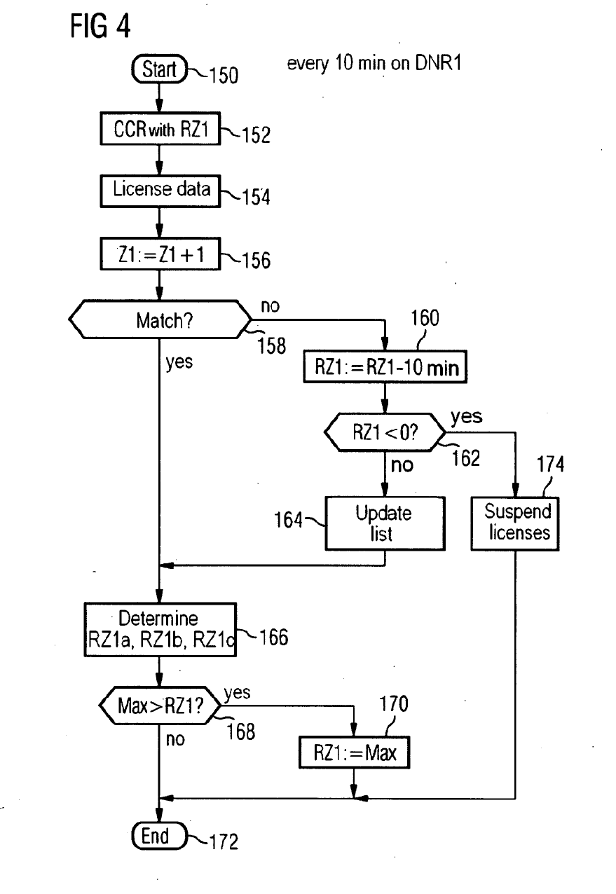

Owing to the receipt of the confirmation message 62 the service using computer 22 enables the use of the two service features in the requested scope. A timer component for specifying a monitoring cycle is started. In the exemplary embodiment the monitoring interval is ten minutes. The first monitoring interval expires at a time t12. In the service using computer 22 the method steps explained in more detail with reference to FIG. 4 are performed. In the process a monitoring message 64 is also generated and sent to the service providing computer 20. As well as the network address of the service using computer 22 the monitoring message 64 contains, inter alia, the current additional usage period RZ1. The monitoring message 64 is also referred to as a CCR (Cyclic Check Request) message.

After receiving the monitoring message 64 the service providing computer 20 adjusts the additional usage period RZ1, i.e. it takes over the time specified in the monitoring message 64 as a value for the additional usage period date 36. Then, at a time t14, the service providing computer 20 sends a response message 66 in which the current license data of the service using computer 22 is recorded.

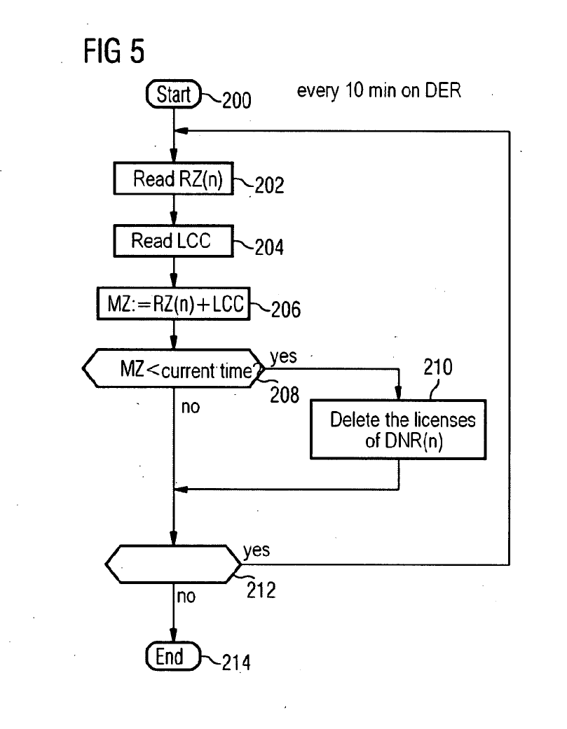

At a time t16, after receiving the response message 66, the service using computer 22 performs check steps which are likewise explained in more detail below with reference to FIG. 4. There is then a period of waiting for the next monitoring interval to expire, whereupon, at a time t18, a monitoring message 70 is again sent by the service using computer 22. Further monitoring steps 80 are indicated by three dots. The monitoring method is terminated when the service using computer 22 returns its licenses to the service providing computer 20 or in the event of a disruption, in which case the method steps explained below with reference to FIGS. 4 and 5 are executed.

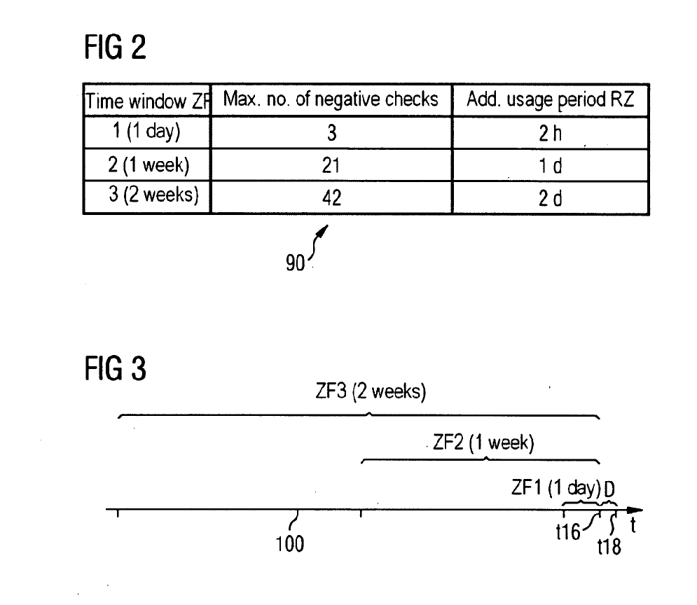

FIG. 2 shows a table 90 which is used for specifying additional usage periods RZ. The numbers and length of three time windows are entered in the first column of the table 90. The maximum allowed number of negative monitoring steps is recorded for each time window in the center column of the table 90. Specified in the right-hand column of the table 90 is an additional usage period that is made available to the service using computer 22 for the respective time window if the maximum number of negative monitoring steps is not exceeded. A time window ZF1 has a length of one day. The maximum number of negative monitoring steps in one day is three for the time window ZF1. The additional usage period RZ1a granted, for example, to the first service using computer 22 for the time window ZF1 is then two hours. A time window ZF2 has a duration of one week. The maximum number of permitted negative monitoring steps for the time window ZF2 is 21. If this number is not exceeded, an additional usage period RZ1b of one day is granted. A time window ZF3 has a length of two weeks. The maximum number of negative monitoring steps specified for the time window ZF3 is 42. If the number specified for the time window ZF3 is not exceeded, the granted additional usage period RZ1c is two days.

FIG. 3 shows a timeline 100 for illustrating the position of the time windows ZF1, ZF2 and ZF3 referred to the time t16 shown with reference to FIG. 1. The time window ZF1 extends from time t16 one day into the past. The time window ZF2 extends from time t16 one week into the past. The time window ZF3, on the other hand, extends from time t16 two weeks into the past, i.e. the time window ZF1 begins one day or 24 hours before time t16 and ends at time t16. At the following check time t18 the position of the time windows ZF1, ZF2 and ZF3 shifts to the right in each case by a time period D which coincides with the duration of a monitoring interval, i.e. by ten minutes in the exemplary embodiment.

FIG. 4 shows method steps that are performed on the service using computer 22 every ten minutes after a monitoring interval has expired. The method begins in each case in a method step 150. In a following method step 152 the monitoring message (CCR—Cyclic Check Request) is sent to the service providing computer 20; see monitoring messages 64 and 70 in FIG. 1. The monitoring message sent in method step 152 contains the current additional usage period RZ1 for the service using computer 22.

In a method step 154 the arrival of the response message from the service providing computer 20 is awaited. When the response message arrives, see response message 66 in FIG. 1, or after a predefined waiting time of, for example, 30 seconds has expired, a cycle counter Z1 is incremented by the value 1 in a method step 156.

Next, in a method step 158, a check is made to determine whether the response message 154 was received within the predefined waiting time and whether the license data contained in the response message matches the current license data for the service using computer 22. If this is not the case, then method step 158 is immediately followed by a method step 160. In method step 160 the additional usage period RZ1 is reduced by ten minutes because of an error in the monitoring. Next, in a method step 162 following method step 160, a check is made to determine whether the return time RZ1 is already less than 0. If this is not the case, then method step 162 is immediately followed by a method step 164, in which a list is updated in which the incorrect monitoring steps are recorded by storing of the respective counter readings Z1. For example, the list 43 contains data fields for entries. If all the data fields are filled, the value of the data field with the oldest entry is overwritten.

Also in method step 164, a license request message, corresponding to the license request message 60 according to FIG. 1, is sent to the service providing computer 20 if license data has in fact been received in method step 154, but this does not tally with the license data stored in the service using computer 22, e.g. because of a reset operation in the service providing computer 20. When the license request message arrives, the service providing computer 20 updates the license data 34 and if applicable sends a confirmation message, corresponding to the confirmation message 62 according to FIG. 1. By means of this approach the monitoring method is continued even in the event of a reset in the service providing computer.

Method step 164 is followed by a method step 166. Method step 166 is also performed immediately after method step 158 if a match between the license data has been established. In method step 166 the return times RZ1a, RZ1b and RZ1c are determined for the time windows ZF1, ZF2 and ZF3 respectively. In this case the following procedure, for example, is performed:
for the time window ZF1, the counter value of the counter Z1 is reduced by the number of monitoring intervals in the time window ZF1, i.e. by 144. The start of the time window ZF1 is thus determined.
For the time window ZF2, the number of monitoring intervals in the time window ZF2 is subtracted from the current number in the counter Z1, i.e. the value 1008, and
for the time window ZF3, the value in the counter Z1 is reduced by the number of monitoring intervals in the time window ZF3, i.e. by 2016.

The end of the respective time window ZF1, ZF2 and ZF3 is specified by the current counter reading in the counter Z1. In order to establish whether the criteria for assigning the respective additional usage period RZ1a, RZ1b or RZ1c have been fulfilled, the list for the respective time window ZF1, ZF2 and ZF3 is searched. The search is started for example at the end of the list, i.e. with the newest entry. If the number of entries lying within the limits of the respective time window ZF1, ZF2 or ZF3 is greater than the maximum number of predefined incorrect monitoring steps according to table 90, the check for the time window ZF1, ZF2 or ZF3 is aborted, in which case the additional usage period Rz1a, Rz1b or Rz1c or, as the case may be, the return time for said time window ZF1, ZF2 or ZF3 must be set to the value 0. Otherwise the check is aborted as soon as a value lying outside the limits of the time window ZF1, ZF2 or ZF3 is read in the list, in which case the additional usage period RZ1a, RZ1b or RZ1c is set for the relevant time window ZF1, ZF2 or ZF3 according to table 90, right-hand column.

The highest thus determined return time or, as the case may be, additional usage period RZ1a, RZ1b or RZ1c is then determined and compared, in a method step 168, with the current return time RZ1. If the maximum return time determined in method step 166 is greater than the current return time RZ1, method step 168 is immediately followed by a method step 170. In method step 170 the maximum return time determined in method step 166 is stored as a value of the return time or, as the case may be, additional usage period RZ1. After method step 170 the current monitoring cycle is terminated in method step 172. Method step 172 immediately follows method step 168 if it is established in method step 168 that the maximum value determined in method step 166 is not greater than the current additional usage period RZ1.

If it is established in method step 162 that the additional usage period RZ1 is less than 0, i.e. the granted bonus has been used up, method step 162 is immediately followed by a method step 174 in which the use of the licensable service features with the identifiers ID1 and ID2 is suspended on the service using computer 22. Method step 174 is followed by method step 172. Together with the suspension of the licenses, the counter for determining the monitoring interval is also stopped, for example. The method steps explained with reference to FIG. 4 are also performed in the same way on the service using computer 24 or, as the case may be, on further service using computers. FIG. 5 shows method steps that are performed by the service providing computer 20. The method steps shown in FIG. 5 are executed cyclically by the service providing computer 20 in each case once in each monitoring interval. In the exemplary embodiment a monitoring interval is ten minutes. The method begins in each case in a method step 200. In a method step 202 following method step 200 the additional usage period RZ1 of the first service using computer 22 is read from the memory 32. In addition, the time of receipt of the last CCR message from the service using computer 22 is read from the memory 32. This time is referred to as the LCC (Last Cyclic Check).

In a method step 206 a maximum time MZ is determined by addition of the additional usage period RZ1 and the time LCC. In a method step 208 it is checked whether the maximum time MZ is less than the current time. If this is the case, method step 208 is immediately followed by a method step 210 in which the licenses that have been allocated to the service using computer 22 are released again. At the same time license data is modified in the memory 32. Method step 210 is immediately followed by a method step 212.

Method step 212 also immediately follows method step 208 if it is established in method step 208 that the maximum time is greater than the current time, i.e. the additional usage period RZ1 has not yet been used up. It is checked in method step 212 whether licenses have been allocated to further service using computers, for example to the service using computer 24. If this is the case, method step 212 is immediately followed by method step 202. The method is contained in a loop consisting of the method steps 202 to 212. When this loop is executed, the method steps just explained for the service using computer 22 are performed in the same manner for the other service using computers. The loop consisting of the method steps 202 to 212 is exited in method step 212 only when the check has been carried out for all service using computers 22, 24 to which licenses have been allocated. Once the check for all service using computers has been completed, method step 212 is immediately followed by a method step 214 in which the current monitoring cycle is terminated.

The methods explained with reference to FIGS. 4 and 5 execute asynchronously with respect to one another, thereby distributing the network load caused by the monitoring methods.

In summary it holds that the explained floating license system results in a high availability in the use of service features which is required in particular in telecommunications systems. Furthermore the reliability of the usage and of the method is high. The reliability of the floating license system is an important precondition for the operation of the system in communications networks.

In other exemplary embodiments the order of the method steps is changed, in particular the order of method steps contained within an unbranched subsection of a flow chart according to FIG. 4 or FIG. 5.

1.-15. (canceled)

16. A method for operating a data communications network, comprising:
generating a license data specifying usage conditions for a use of a function in the data communications network;
using the function on a service using computer of the data communications based on the license data;
monitoring a compliance with the usage conditions by a service providing computer;
specifying an additional usage period based on problems disrupting the monitoring, and
wherein the use of the function is dependent on the additional usage period in the event of a problem disrupting the monitoring.

17. The method as claimed in claim 16, wherein the license data specifies a number of simultaneous uses of the function in the data communications network.

18. The method as claimed in claim 16, wherein the function relates to an invocation and use of a program or a program part, or that the function relates to the use of a switching unit or a subfunction of a switching unit.

19. The method as claimed in claim 16, further comprising:
specifying a check time window, an additional usage period belonging to the check time window and a check criterion belonging to the check time window, the check criterion is a measure for a number of allowed disruptions to the monitoring;
determining a number disruptions that have occurred in the check time window;
comparing of the check criterion with the determined disruptions; and
specifying the additional usage period based on the comparison.

20. The method as claimed in claim 19, wherein the time window has a variable start time and an end time defined by a current time and the length of the time window is constant.

21. The method as claimed in claim 20, wherein
the length of the time window is one day plus or minus ten percent and the associated additional usage period is two hours plus or minus ten percent,
the length of the time window is one week plus or minus ten percent and associated additional usage period is one day plus or minus ten percent, or
the length of the time window is two weeks plus or minus ten percent and associated additional usage period is two days plus or minus ten percent.

22. The method as claimed in claim 19, wherein the monitoring is automatically repeated based on a predefined monitoring interval.

23. The method as claimed in claim 19,
wherein the monitoring is not possible during a monitoring interval when a problem disrupts the monitoring, and
wherein the length of the monitoring interval is from five minutes to one hour.

24. The method as claimed in claim 23, wherein the length of the monitoring interval is ten minutes,

25. The method as claimed in claim 23, wherein
the length of the time window is one day, a minimum availability of the monitoring is from 95 percent to 100 percent and additional usage period is two hours,
the length of the time window is one week, a minimum availability of the monitoring is from 95 percent to 100 percent and additional usage period is one day, or
the length of the time window is two weeks, a minimum availability of the monitoring is from 95 percent to 100 percent and additional usage period is two days.

26. The method as claimed in claim 22, wherein a plurality of time windows and associated additional usage periods and associated availability criteria are defined, that the availability criteria for the plurality of time windows are checked, and that if several availability criteria have been fulfilled for the time windows, the greatest additional usage period defined for these time windows is chosen and used as the additional usage period.

27. The method as claimed in claim 22, wherein the service providing computer monitors the use of the function of the service using computer.

28. The method as claimed in claim 22, wherein the usage conditions specify the use of a plurality of different functions and that the additional usage period relates to the use of the plurality of functions.

29. The method as claimed in claim 22, further comprising by the service using computer:
sending a monitoring message to the service providing computer;
reducing the additional usage period by the predefined amount in response to not receiving a response message to the monitoring message or in response to receiving an incorrect response message;
checking the remaining additional usage period; and
suspending use of the function in response to an expiration of the additional usage period.

30. The method as claimed in claim 29, wherein the sending, the reducing, the checking, and the suspending are cyclically repeated based on the predefined amount.

31. The method as claimed in claim 22, further comprising by the service providing computer:
reading an additional usage period date for the service using computer, the value of the additional usage period date specifying the additional usage period;
reading a monitoring date that specifies the time of the last message received from the service using computer during the monitoring;
checking whether the additional usage period has been exceeded as a function of the value of the monitoring date; and
updating the license data for a release of licenses that have been allocated to the service using computer in response to exceeding the additional usage period.

32. The method as claimed in claim 31, wherein the reading the additional usage period, the reading the monitoring date, the checking, and the updating are cyclically repeated.

33. A device network, comprising:
a service using computer, dependent on license data and uses a function, the service using computer comprising:
a unit that specifies an additional usage period taking into account problems disrupting the monitoring,
a monitoring message that is sent to the service providing computer, such that the additional usage period is reduced by a predefined amount in response to not receiving a response to the monitoring message or in response to receiving an incorrect response to the monitoring message, and
a checking unit that checks the remaining additional usage period, such that the use of the function by the service using computer is suspended in response to an expiration of the additional usage period; and
a service providing computer that monitors a compliance with the usage conditions for the use of the function in the license data, the service providing computer comprising:
a unit that enables a use for the specified additional usage period in response to a disruption of the monitoring and that bars a use going beyond the additional usage period,
a monitoring date that specifies the time of the last message received from the service using computer during the monitoring, and
a checking unit that checks whether the additional usage period has been exceeded as a function of the value of the monitoring date, such that the license data is updated for a release of licenses allocated to the service using computer in response to exceeding the additional usage period.
